(19) United States
(12) Patent Application Publication
(10) Pub. No.: US 2022/0299135 A1
(43) Pub. Date: Sep. 22, 2022

(54) TUBE FITTING AND ASSEMBLY METHOD THEREFOR

(71) Applicant: SAEMCHAN ENERGY CO., LTD., Seoul (KR)

(72) Inventor: Kwang Chan AN, Seoul (KR)

(21) Appl. No.: 17/621,041

(22) PCT Filed: May 27, 2020
(86) PCT No.: PCT/KR2020/006854

§ 371 Date: Dec. 20, 2021

(30) Foreign Application Priority Data
Jun. 21, 2019 (KR) 10-2019-0073855

(51) Int. Cl. F16L 19/075; F16L 19/065

(52) U.S. Cl. CPC F16L 19/075; F16L 19/065

(57) ABSTRACT

Provided is a tube fitting and an assembly method therefor. The tube fitting includes: a fitting body having a passage formed therein for supplying a fluid, and a plurality of accommodation spaces formed therein and communicating with the passage; a plurality of tube fixtures which are respectively accommodated in the plurality of accommodation spaces in a state of being fixedly coupled to one end of each of a plurality of tubes, and which connect the one end of each of the plurality of tubes to the passage; a plurality of ferrule members which are respectively accommodated in the plurality of accommodation spaces in a state of being respectively in contact with the plurality of tube fixtures, and which respectively maintain airtightness between the inner circumferential surfaces of the plurality of accommodation spaces and the outer circumferential surfaces of the plurality of tubes; and a plurality of nut bodies which are respectively coupled to the plurality of accommodation spaces to fix the plurality of tube fixtures and the plurality of ferrule members respectively to the plurality of accommodation spaces.

### TECHNICAL FIELD

The present invention relates to a tube fitting and an assembly method therefor, and relates to a tube fitting and an assembly method therefor, which can prevent a tube from being separated from the tube fitting and more stably connect a plurality of tubes with a simpler structure.

### BACKGROUND ART

In general, a tube refers to a small-diameter pipe for supplying a fluid such as gas or liquid, and a tube fitting refers to a pipe joint part used to connect a plurality of tubes to each other. Since such a tube fitting should not leak a fluid at a joint connecting a plurality of tubes, tube fittings having various structures have been developed.

For example, Korean Patent Registration No. 10-1612064 (entitled “Tube Fitting Member for Ultra-high Vacuum and Ultra-high Pressure) (published on Apr. 12, 2016) discloses a tube fitting including a nut part 20, a rear ferrule 30, a front ferrule 40, and a body part 70.

That is, the tube fitting disclosed in the Korean Patent Registered No. 10-1612064 has a structure in which the nut part 20, the rear ferrule 30, and the front ferrule 40 are fitted to the tube 10, and the body part 70 and the nut part 20 are screwed such that the end of the tube 10 is inserted into a stepped protrusion 72 of the body part 70, whereby the tube 10 is fixed by the rear ferrule 30 and the front ferrule 40.

However, since the conventional tube fitting has a structure in which the tube 10 is fixed only by the rear ferrule 30 and the front ferrule 40, there is a problem in that the tube 10 is separated from the tube fitting when the fixing force by the rear ferrule 30 and the front ferrule 40 is weak. In particular, when a fluid supplied through the tube 10 is a high-pressure gas, there is a problem that the separation of the tube 10 occurs more frequently.

In order to solve these problems, tube fittings having various structures have been developed to improve the fixing force of the tube 10. However, the structure for improving the fixing force of the tube 10 is somewhat complicated, and accordingly, there is a problem in that it is difficult to assemble and disassemble the tube 10 for the tube fitting.

Therefore, there is a need for a tube fitting and an assembly method therefor, which can prevent a tube from being separated from the tube fitting and more stably connect a plurality of tubes with a simpler structure.

### SUMMARY OF INVENTION

### Technical Problem

The present invention has been made in an effort to solve the above problems, and an object of the present invention is to provide a tube fitting and an assembly method thereof, wherein a tube fixture in which one end of a tube is fixedly coupled to an accommodation space of a fitting body is accommodated and is fixed with a ferrule member and a nut body, and thus it is possible to prevent the tube from being separated from the tube fitting with a simpler structure, thereby more stably connecting a plurality of tubes.

The objects of the present invention are not limited to the above object, and other objects that are not mentioned herein will be clearly understood by those of ordinary skill in the art from the following description.

### Solution to Problem

In order to achieve the object, a tube fitting according to an embodiment of the present invention includes: a fitting body having a passage formed therein for supplying a fluid, and a plurality of accommodation spaces formed therein and communicating with the passage; a plurality of tube fixtures which are respectively accommodated in the plurality of accommodation spaces in a state of being fixedly coupled to one end of each of a plurality of tubes, and which connect the one end of each of the plurality of tubes to the passage; a plurality of ferrule members which are respectively accommodated in the plurality of accommodation spaces in a state of being respectively in contact with the plurality of tube fixtures, and which respectively maintain airtightness between the inner circumferential surfaces of the plurality of accommodation spaces and the outer circumferential surfaces of the plurality of tubes; and a plurality of nut bodies which are respectively coupled to the plurality of accommodation spaces to fix the plurality of tube fixtures and the plurality of ferrule members respectively to the plurality of accommodation spaces.

Preferably, a male thread is formed on the outer circumferential surface of one end of each of the plurality of tubes, a female thread is formed on the inner circumferential surface of each of the plurality of tube fixtures, and each of the plurality of tubes and each of the plurality of tube fixtures are screwed to each other.

In addition, each of the plurality of ferrule members is provided with a protrusion pressing the outer circumferential surface of each of the plurality of tubes.

On the other hand, in order to achieve the object, a tube fitting assembly method according to an embodiment of the present invention includes: fixedly coupling one end of each of a plurality of tubes to a plurality of tube fixtures; inserting the plurality of tube fixtures into a plurality of accommodating spaces formed in a fitting body to connect one end of each of the plurality of tubes to a passage formed in the fitting body; inserting a plurality of ferrule members for maintaining airtightness between the inner circumferential surface of each of the plurality of accommodation spaces and the outer circumferential surface of each of the plurality of tubes into the plurality of accommodation spaces so as to contact each of the plurality of tube fixtures; and fastening a plurality of nut bodies to the plurality of accommodation spaces to fix the plurality of tube fixtures and the plurality of ferrule members to the plurality of accommodation spaces.

In this case, the fixedly coupling of one end of each of the plurality of tubes to the plurality of tube fixtures includes: forming a male thread on the outer circumferential surface of one end of each of the plurality of tubes; and screwing the male thread formed on each of the plurality of tubes to a female thread formed on the inner circumferential surface of each of the plurality of tube fixtures.

Specific matters of other embodiments are included in the detailed description and drawings.

### Advantageous Effects of Invention

In a tube fitting and an assembly method thereof according to embodiments of the present invention, a tube fixture in which one end of a tube is fixedly coupled to an accommodation space of a fitting body is accommodated and is fixed with a ferrule member and a nut body, and thus it is possible to prevent the tube from being separated from the tube fitting with a simpler structure, thereby more stably connecting a plurality of tubes.

In a tube fitting and an assembly method thereof according to embodiments of the present invention, the tube is screwed to the tube fixture fixed by the ferrule member and the nut body, thereby easily and firmly connecting the tube and the tube fixture with a simpler structure.

In addition, in a tube fitting and an assembly method thereof according to embodiments of the present invention, a protrusion is formed on the ferrule member accommodated in the accommodation space of the fitting body and performing a sealing role so as to fix the outer circumferential surface of the tube, thereby fixedly connecting the tube more firmly by the tube fixture and the ferrule member.

The effects of the present invention are not limited to the above objects, and other objects that are not mentioned herein will be clearly understood by those of ordinary skill in the art from the claims.

### BRIEF DESCRIPTION OF DRAWINGS

FIG. 1 is a perspective view showing a structure of a tube fitting according to an embodiment of the present invention.

FIG. 2 is an exploded perspective view showing the structure of the tube fitting according to an embodiment of the present invention.

FIG. 3 is a longitudinal cross-sectional view showing the structure of the tube fitting according to an embodiment of the present invention.

FIG. 4 is a view showing an example of a tube fixture constituting the tube fitting according to an embodiment of the present invention.

FIG. 5 is a flowchart showing a process of assembling a tube fitting according to an embodiment of the present invention.

FIGS. 6 to 8 are views showing a process of assembling a tube fitting according to an embodiment of the present invention.

### DESCRIPTION OF EMBODIMENTS

Hereinafter, preferred embodiments of the present invention will be described with reference to the accompanying drawings, so that those of ordinary skill in the art can easily carry out the present invention.

In describing the embodiments, descriptions of technical contents that are well known in the technical field to which the present invention pertains and are not directly related to the present invention will be omitted. By omitting unnecessary description, the present invention can be described more clearly without obscuring the gist of the present invention.

For the same reason, some elements in the accompanying drawings are exaggerated, omitted, or schematically illustrated. Also, the size of each element does not entirely reflect the actual size. The same reference numerals are assigned to the same or corresponding elements in the drawings.

In addition, the expressions and predicates used herein with respect to the terms such as device or element directions (for example, “front”, “back”, “up”, “down”, “top”, “bottom”, “left”, “right”, “lateral”, and the like) are only used to simplify the description of the present invention, and do not simply indicate or imply that the related device or element should have a particular direction.

Hereinafter, the present invention will be described with reference to the drawings for explaining a tube fitting and an assembly method therefor according to embodiments of the present invention.

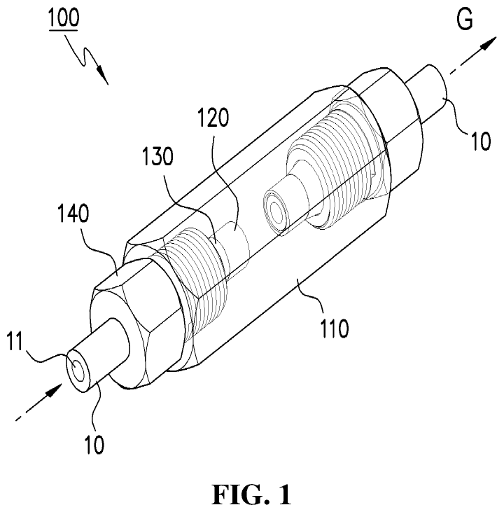

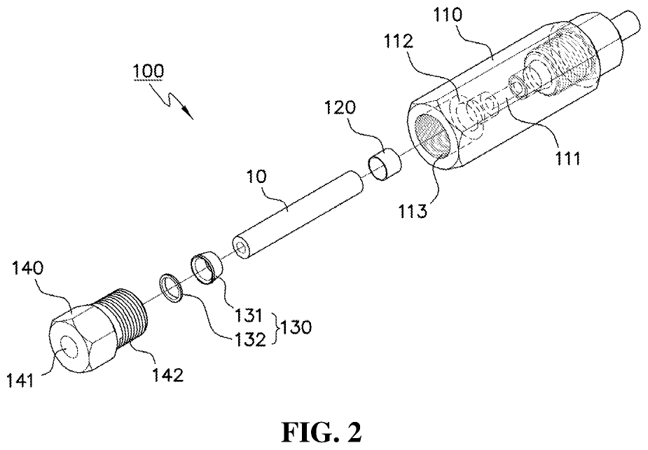

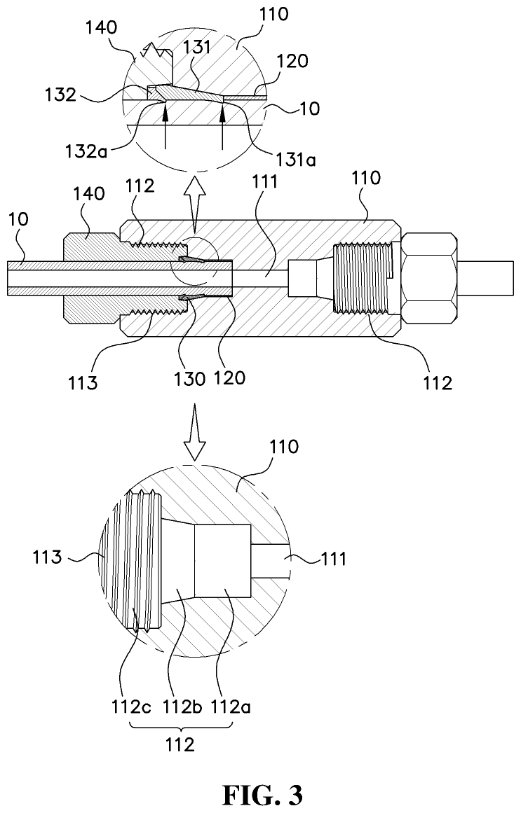

FIG. 1 is a perspective view showing a structure of a tube fitting according to an embodiment of the present invention, FIG. 2 is an exploded perspective view showing the structure of the tube fitting according to an embodiment of the present invention, and FIG. 3 is a longitudinal cross-sectional view showing the structure of the tube fitting according to an embodiment of the present invention.

As shown in FIGS. 1 to 3, a tube fitting 100 according to an embodiment of the present invention may include a fitting body 110, a tube fixture 120, a ferrule member 130, and a nut body 140.

The fitting body 110 may have a passage 111 through which a fluid G is supplied, and a plurality of accommodation spaces 112 communicating with the passage 111 may be formed therein. In the present invention, the fluid G is a broad concept including various types of gases and liquids, but in particular, refers to a gas in a high-pressure state.

The accommodation space 112 is a space in which a tube 10, the tube fixture 120 for fixing the tube 10, the ferrule member 130, and the nut body 140 are sequentially accommodated therein, and a plurality of accommodation spaces 112 may be formed on at least one side of the fitting body 110 through which the fluid G is introduced and at least one other side of the fitting body 110 through which the fluid G is discharged.

As shown in FIG. 3, each of the accommodation spaces 112 may include a first accommodation space 112a which communicates with the passage 111 and in which the tube fixture 120 is accommodated, a second accommodating space 112b which communicates with the first accommodating space 112a and in which the ferrule member 130 is accommodated, and a third accommodating space 112c which communicates with the second accommodating space 112b and in which the nut body 140 is accommodated. As will be described below, a female thread 113 to which the nut body 140 is screwed may be formed on the inner circumferential surface of the third accommodating space 112c in which the nut body 140 is accommodated.

In the present invention, a case in which the tube fitting 100 connects two tubes 10 is described as an example. In this case, as shown in FIGS. 1 to 3, the fitting body 110 is elongated in a substantially straight shape, and two accommodation spaces 112 may be formed on one side of the fitting body 10 (lower left in the example of FIG. 1) through which the fluid G is introduced and the other side of the fitting body 110 (upper right in the example of FIG. 1) through which the fluid G is discharged.

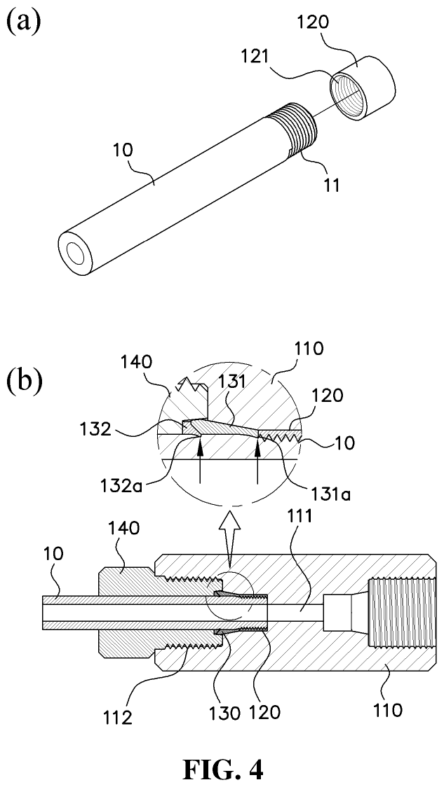

The tube fixture 120 may be accommodated in each accommodation space 112 (in the example of FIG. 3, the first accommodation space 112a) formed in the fitting body 110, and may fix one end of the tube 10 to the accommodation space 112 so as to be connected to the passage 111 communicating with the accommodation space 112. The tube fixture 120 may be firmly fixed to the accommodation space 112 by the ferrule member 130 and the nut body 140 accommodated following the accommodation space 112. A detailed structure of the tube fixture 120 will be described in detail with reference to FIG. 4.

After the tube fixture 120 is accommodated in each accommodation space 112 (in the example of FIG. 3, the first accommodation space 112a), the ferrule member 130 may be accommodated in each accommodation space 112 (in the example of FIG. 3, the second accommodation space 112b) so as to contact each tube fixture 120. As shown in FIG. 2, each of the ferrule members 130 may have a ring shape surrounding the outer circumferential surface of the tube 10.

At least one ferrule member 130 is provided as necessary, and may maintain airtightness between the inner circumferential surface of the accommodation space 112 and the outer circumferential surface of the tube 10 to prevent the fluid G supplied through the tube 10 from leaking out of the tube fitting 100.

FIGS. 2 and 3 illustrate an example in which two ferrule members 131 and 132 are arranged side by side in the accommodation space 112 of the fitting body 110 (in the example of FIG. 3, the second accommodation space 112b), the first ferrule member 131 in contact with the tube fixture 120 has a ring shape with an inclined surface and an elongated cross-section, and the second ferrule member 132 in contact with the first parallel member 131 has a ring shape with an inclined surface and a triangular cross-section, but the number, shape, and the like of ferrule members 130 may be freely changed by those of ordinary skill in the art.

On the other hand, as shown in FIG. 3, the ferrule members 131 and 132 are preferably provided with protrusions 131a and 132a that press the outer circumferential surface of the tube 10. In this case, the ferrule members 131 and 132 may be made of a material having a hardness and strength higher than those of the tube 10. That is, as shown in FIG. 3, since the protrusions 131a and 132a have an inner diameter smaller than an outer diameter of the tube 10, the protrusions 131a and 132a may serve to fix the tube 10 by pressing the outer circumferential surface of the tube 10 after being press-fitted to the tube 10 having a soft material such as rubber.

FIG. 3 shows an example in which the first protrusion 131a is formed at one end of the first ferrule member 131 in contact with the tube fixture 120, and the second protrusion 132a is formed at one end of the second ferrule member 132 in contact with the first ferrule member 131. However, the number, shape, formation position, and the like of the protrusions 131a and 132a may be freely changed by those of ordinary skill in the art.

As such, when the protrusions 131a and 132a are formed on the ferrule members 131 and 132, the ferrule members 131 and 132 may maintain airtightness between the inner circumferential surface of the accommodation space 112 and the outer circumferential surface of the tube 10, and may also fix the tube 10 by itself. Therefore, the tube 10 may be more firmly fixedly coupled to the accommodation space 112 of the fitting body 110 by the tube fixture 120 and the ferrule member 130.

In a state in which the tube fixture 120 and the ferrule member 130 are already accommodated in each of the accommodation spaces 112 (in the example of FIG. 3, the first accommodation space 112a and the second accommodation space 112b), the nut body 140 may be fastened to the accommodation space 112 (in the example of FIG. 3, the third accommodation space 112c) so as to fix the tube fixture 120 and the ferrule member 130 to the accommodation space 112 (in the example of FIG. 3, the first accommodation space 112a and the second accommodation space 112b).

As shown in FIGS. 2 and 3, the nut body 140 has a substantially cylindrical shape. The nut body 140 may be provided with a through hole 141 through which the fluid G is introduced or discharged along the length direction, and a male thread 142 at one end so as to be screwed to the female thread 113 formed in the accommodation space 112 (in the example of FIG. 3, the third accommodation space 112c) of the fitting body 110.

On the other hand, the tube fixture 120 constituting the tube fitting 100 according to an embodiment of the present invention may be accommodated in the accommodation space 112 in a state of being fixedly coupled to one end of the tube 10. That is, the tube fixture 120 may be accommodated in the accommodation space 112 together with one end of the tube 10 after one end of the tube 10 is fixedly coupled.

Therefore, since the tube 10 can be assembled and disassembled for the accommodation space 112 only in a state of being coupled to the tube fixture 120, there is little possibility of being separated from the accommodation space 112 in a state in which the tube fixture 120 is fixed to the accommodation space 112.

Preferably, the tube fixture 120 constituting the tube fitting 100 according to an embodiment of the present invention may be screwed to the tube 10.

FIG. 4 is a view showing an example of the tube fixture constituting the tube fitting according to an embodiment of the present invention.

As shown in FIG. 4, a male thread 11 may be formed on an outer circumferential surface of one end of a tube 10, and a female thread 121 may be formed on an inner circumferential surface of a tube fixture 120. As such, since the tube 10 and the tube fixture 120 are screwed to each other and the tube fixture 120 is fixedly coupled to the accommodation space 112 of the fitting body 110 by the ferrule member 130 and the nut body 140, it is possible to prevent the tube 10 from being separated from the tube fitting 100 with a simpler structure.

On the other hand, FIG. 4 shows an example in which the tube 10 and the tube fixture 120 are screwed to each other, but any structure is possible as long as the tube 10 and the tube fixture 120 can be fixedly coupled to each other before being accommodated in the accommodation space 112 of the fitting body 110.

As such, in the tube fitting 100 according to an embodiment of the present invention, after the tube fixture 120 to which one end of the tube 10 is fixedly coupled to the accommodation space 112 of the fitting body 110 is accommodated and fixed to the ferrule member 130 and the nut body 140. Therefore, since it is possible to prevent the tube 10 from being separated from the tube fitting 100 with a simpler structure, the plurality of tubes 10 can be more stably connected.

In addition, by screwing the tube fixture 120 and the tube 10 fixed by the ferrule member 130 and the nut body 140, the tube 10 and the tube fixture 120 can be easily and firmly coupled to each other with a simpler structure.

In addition, protrusions 131a and 132a are formed on the ferrule member 130 accommodated in the accommodation space 112 of the fitting body 110 and performing a sealing role so as to fix the outer circumferential surface of the tube 10, thereby fixedly connecting the tube 10 more firmly by the tube fixture 120 and the ferrule member 130.

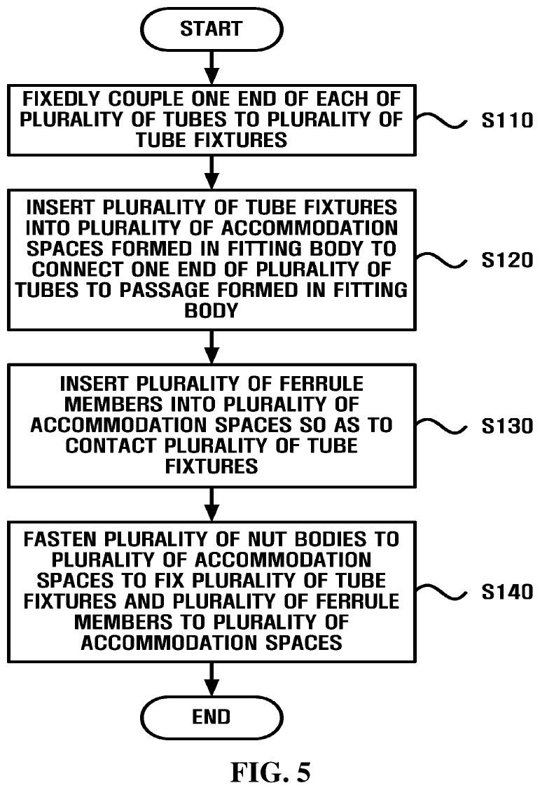

Hereinafter, a process of assembling the tube fitting 100 according to an embodiment of the present invention will be described with reference to FIGS. 5 to 8.

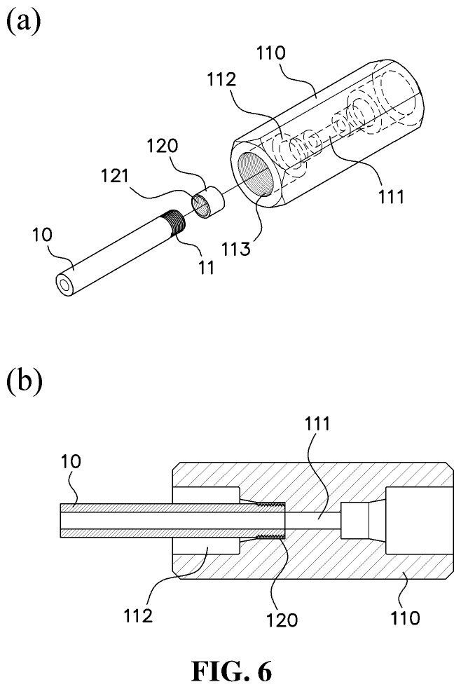

FIG. 5 is a flowchart showing a process of assembling a tube fitting according to an embodiment of the present invention, and FIGS. 6 to 8 are views showing a process of assembling a tube fitting according to an embodiment of the present invention.

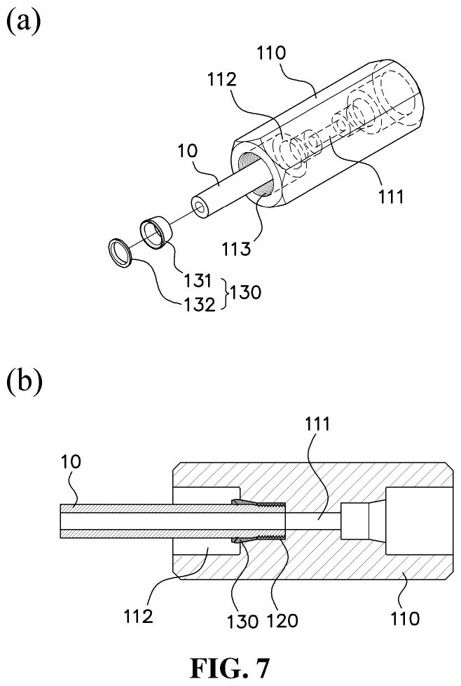

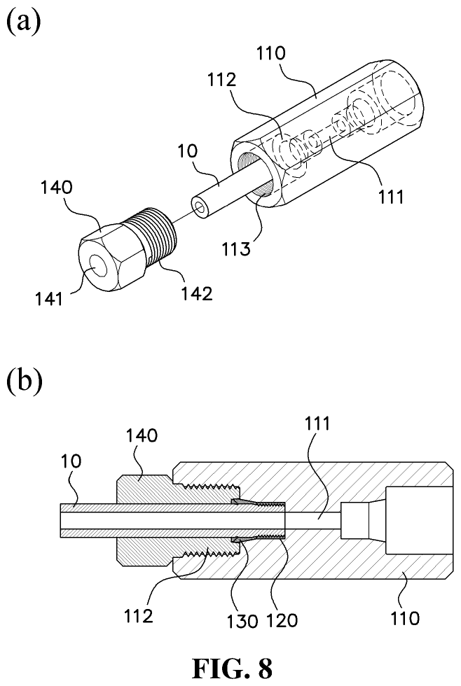

(a) and (b) of FIG. 6 show a state in which a tube fixture 120 to which a tube 10 is fixedly coupled is inserted into an accommodation space 112 formed in a fitting body 110, (a) and (b) of FIG. 7 show a state in which a ferrule member 130 is inserted into the accommodation space 112 formed in the fitting body 110, and (a) and (b) of FIG. 8 show a state in which a nut body 140 is coupled to the accommodation space 112 formed in the fitting body 110.

First, as shown in FIG. 5 and (a) of FIG. 6, one end of the tube 10 may be fixedly coupled to the tube fixture 120 (S110). As described above, the tube fixture 120 constituting the tube fitting 100 according to an embodiment of the present invention is preferably screwed to the tube 10.

That is, the step S110 of fixing one end of the tube 10 to the tube fixture 120 may include forming a male thread 11 on the outer circumferential surface of one end of the tube 10, and screwing the male thread 11 formed at one end of the tube 10 to a female thread 121 formed on the inner circumferential surface of the tube fixture 120.

Although not shown, in general, since each tube 10 is already connected to various parts and devices, the tube fixture 120 is rotated to be screwed to one end of the tube 10 in a state in which the tube 10 is gripped by a user.

As shown in FIG. 5 and (b) of FIG. 6, the tube fixture 120 to which one end of the tube 10 is previously fixedly coupled is inserted into the accommodation space 112 formed in the fitting body 110, so that one end of the tube 10 may be connected to a passage 111 formed in the fitting body 110 (S120).

As shown in FIGS. 5 and 7, the ferrule member 130 for maintaining airtightness between the inner circumferential surface of the accommodation space 112 and the outer circumferential surface of the tube 10 may be sequentially inserted into the accommodation space 112 to contact the tube fixture 120 (S130).

Finally, the nut body 140 may be fastened to the accommodation space 112 to fix the tube fixture 120 and the ferrule member 130 to the accommodation space 112 (S140).

On the other hand, in the present specification and the drawings, preferred embodiments of the present invention are disclosed. Although certain terms are used, these terms are only used in a general sense to easily explain the technical content of the present invention and to help the understanding of the invention, and are not intended to limit the scope of the present invention. It will be obvious to those of ordinary skill in the art that other modifications based on the technical idea of the present invention may be made thereto.

### INDUSTRIALLY APPLICABILITY

The present invention relates to a tube fitting and an assembly method therefor, and can be applicable to a technical field related to a tube fitting and an assembly method therefor, which can prevent a tube from being separated from the tube fitting and more stably connect a plurality of tubes with a simpler structure.

1. A tube fitting comprising:
a fitting body having a passage formed therein for supplying a fluid, and a plurality of accommodation spaces formed therein and communicating with the passage;
a plurality of tube fixtures which are respectively accommodated in the plurality of accommodation spaces in a state of being fixedly coupled to one end of each of a plurality of tubes, and which connect the one end of each of the plurality of tubes to the passage;
a plurality of ferrule members which are respectively accommodated in the plurality of accommodation spaces in a state of being respectively in contact with the plurality of tube fixtures, and which respectively maintain airtightness between the inner circumferential surfaces of the plurality of accommodation spaces and the outer circumferential surfaces of the plurality of tubes; and
a plurality of nut bodies which are respectively coupled to the plurality of accommodation spaces to fix the plurality of tube fixtures and the plurality of ferrule members respectively to the plurality of accommodation spaces.

2. The tube fitting of claim 1, wherein a male thread is formed on the outer circumferential surface of one end of each of the plurality of tubes, a female thread is formed on the inner circumferential surface of each of the plurality of tube fixtures, and each of the plurality of tubes and each of the plurality of tube fixtures are screwed to each other.

3. The tube fitting of claim 1, wherein each of the plurality of ferrule members is provided with a protrusion pressing the outer circumferential surface of each of the plurality of tubes.

4. A tube fitting assembly method comprising:
fixedly coupling one end of each of a plurality of tubes to a plurality of tube fixtures;
inserting the plurality of tube fixtures into a plurality of accommodating spaces formed in a fitting body to connect one end of each of the plurality of tubes to a passage formed in the fitting body;
inserting a plurality of ferrule members for maintaining airtightness between the inner circumferential surface of each of the plurality of accommodation spaces and the outer circumferential surface of each of the plurality of tubes into the plurality of accommodation spaces so as to contact each of the plurality of tube fixtures; and
fastening a plurality of nut bodies to the plurality of accommodation spaces to fix the plurality of tube fixtures and the plurality of ferrule members to the plurality of accommodation spaces.

5. The tube fitting assembly method of claim 4, wherein the fixedly coupling of one end of each of the plurality of tubes to the plurality of tube fixtures comprises:
forming a male thread on the outer circumferential surface of one end of each of the plurality of tubes; and
screwing the male thread formed on each of the plurality of tubes to a female thread formed on the inner circumferential surface of each of the plurality of tube fixtures.
